(19) United States
(12) Patent Application Publication
(10) Pub. No.: US 2026/0296051 A1
(43) Pub. Date: Oct. 1, 2026

(54) THERMAL PRINT HEAD

(71) Applicant: ROHM CO., LTD., Kyoto-shi (JP)

(72) Inventor: Shoki AKITA, Kyoto-shi (JP)

(21) Appl. No.: 19/572,432

(22) Filed: Mar. 19, 2026

(30) Foreign Application Priority Data
Mar. 26, 2025 (JP) 2025-051755

(51) Int. Cl. B41J 2/35; B41J 2/335

(52) U.S. Cl. CPC B41J 2/35; B41J 2/3351

(57) ABSTRACT

A thermal print head includes: a substrate; a heater glaze; a flattened layer; a wiring layer; and a heat-generating resistor. The flattened layer is contiguous to an end portion of the heater glaze on the substrate. The heat-generating resistor is disposed on the heater glaze. The wiring layer includes a coupling portion extending from the heat-generating resistor toward the flattened layer in a y direction, and an auxiliary electrode portion connected to the coupling portion. The coupling portion, the auxiliary electrode portion, and the flattened layer include a first end portion, a second end portion, and a third end portion farthest from the end portion in the y direction. The second end portion is disposed between the first end portion and the third end portion in the y direction.

### CROSS REFERENCE TO RELATED APPLICATIONS

This nonprovisional application is based on Japanese Patent Application No. 2025-051755 filed on Mar. 26, 2025 with the Japan Patent Office, the entire contents of which are hereby incorporated by reference.

### BACKGROUND OF THE INVENTION

### Field of the Invention

The present disclosure relates to a thermal print head.

### Description of the Background Art

Japanese Patent Laying-Open No. 2019-147300 discloses a thermal print head including a substrate, a wiring layer and a heat-generating resistor. The wiring layer includes a coupling portion and an auxiliary electrode portion disposed on the coupling portion.

### BRIEF DESCRIPTION OF THE DRAWINGS

FIG. 1 is a schematic plan view of a thermal print head according to a first embodiment.

FIG. 2 is a partially enlarged schematic plan view of a region II in FIG. 1.

FIG. 3 is a partially enlarged schematic cross-sectional view taken along line III-III in FIG. 2.

FIG. 4 is a flowchart showing a method for manufacturing the thermal print head according to the first embodiment.

FIG. 5 is a partially enlarged schematic cross-sectional view showing one step in the method for manufacturing the thermal print head according to the first embodiment.

FIG. 6 is a partially enlarged schematic cross-sectional view showing one step in the method for manufacturing the thermal print head according to the first embodiment.

FIG. 7 is a partially enlarged schematic cross-sectional view showing one step in the method for manufacturing the thermal print head according to the first embodiment.

FIG. 8 is a partially enlarged schematic cross-sectional view showing one step in the method for manufacturing the thermal print head according to the first embodiment.

FIG. 9 is a partially enlarged plan view showing the shape of a first end portion of a coupling portion.

FIG. 10 is a partially enlarged schematic cross-sectional view showing one step in the method for manufacturing the thermal print head according to the first embodiment.

FIG. 11 is a partially enlarged schematic cross-sectional view showing one step in the method for manufacturing the thermal print head according to the first embodiment.

FIG. 12 is a partially enlarged schematic cross-sectional view showing one step in the method for manufacturing the thermal print head according to the first embodiment.

FIG. 13 is a partially enlarged schematic plan view of a thermal print head according to a second embodiment.

FIG. 14 is a partially enlarged schematic cross-sectional view taken along line XIV-XIV in FIG. 13.

FIG. 15 is a partially enlarged schematic cross-sectional view taken along line XV-XV in FIG. 13.

### DESCRIPTION OF THE PREFERRED EMBODIMENTS

### Detailed Description

Embodiments of the present disclosure will be described in detail with reference to the drawings. In the drawings, the same or corresponding portions are denoted by the same reference numerals, and the description thereof will not be repeated. At least some of configurations in the embodiments described below may be arbitrarily combined.

### First Embodiment

### Configuration of Thermal Print Head

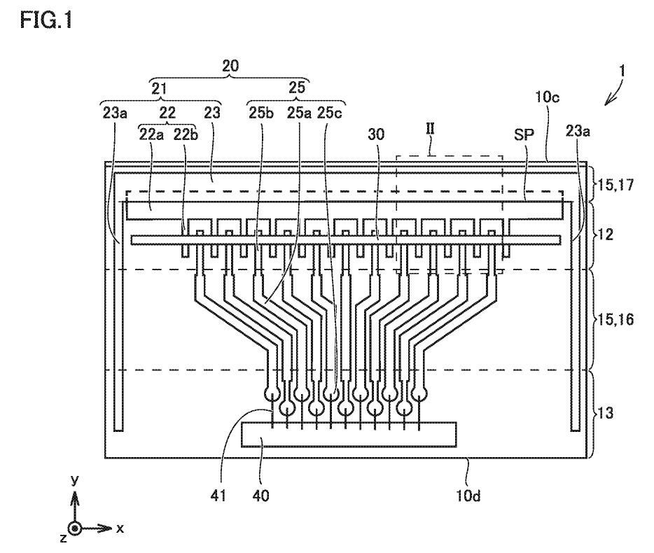

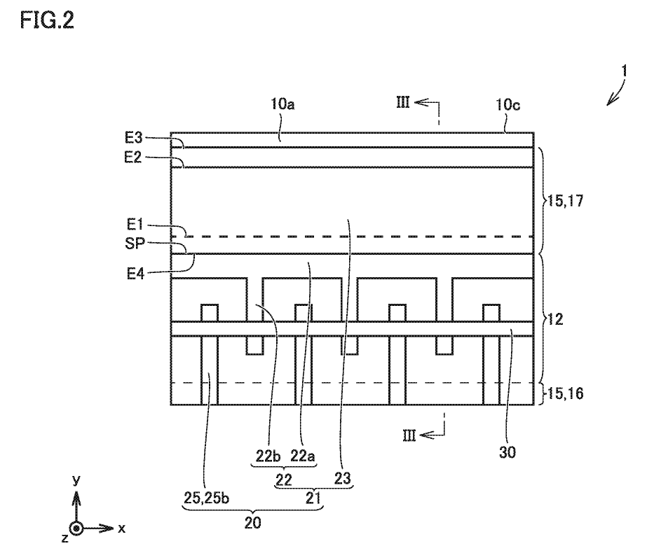

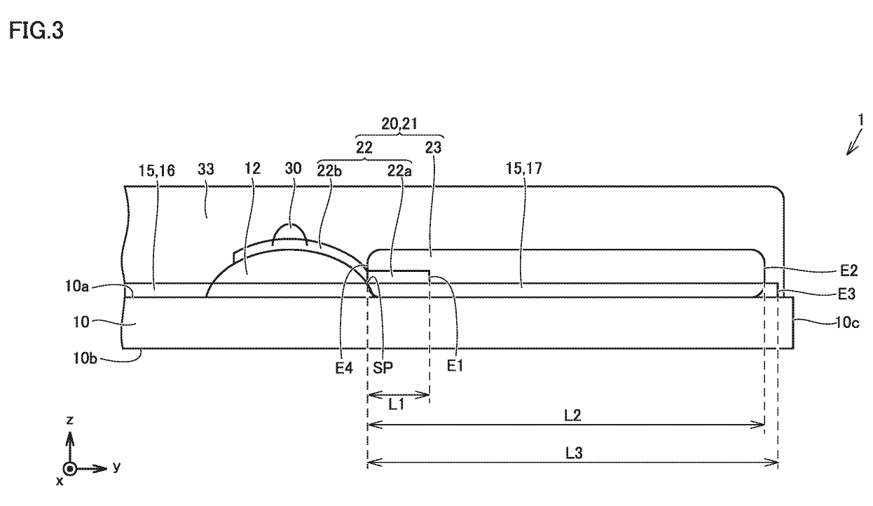

FIG. 1 is a schematic plan view of a thermal print head 1 according to a first embodiment. FIG. 2 is a partially enlarged schematic plan view of a region II in FIG. 1. FIG. 3 is a partially enlarged schematic cross-sectional view taken along line III-III in FIG. 2.

As shown in FIGS. 1-3, thermal print head 1 according to the first embodiment includes a substrate 10, a heater glaze 12, a die bonding glaze 13, a flattened layer 15, a wiring layer 20, a heat-generating resistor 30, a protective layer 33, a drive circuit 40, and a conductive wire 41. In FIGS. 1 and 2, protective layer 33 is not shown.

Substrate 10 is, for example, a ceramic substrate such as an alumina substrate. As shown in FIG. 3, substrate 10 has a first surface 10a, a second surface 10b, a first side surface 10c, and a second side surface 10d. In a plan view of first surface 10a (hereinafter, simply referred to as “plan view”), a longer-side direction of substrate 10 is defined as an x direction. The x direction corresponds to a main scanning direction. A shorter-side direction of substrate 10 is defined as a y direction. The y direction corresponds to a sub-scanning direction. A thickness direction of substrate 10 is defined as a z direction. The z direction is perpendicular to the x direction (main scanning direction) and the y direction (sub-scanning direction). In a plan view, the y direction (sub-scanning direction) corresponds to a conveyance direction of a print medium (e.g., heat-sensitive recording paper). The y direction corresponds to a direction in which a coupling portion 22 extends as described below.

Second surface 10b is located opposite to first surface 10a in the z direction. Each of first side surface 10c and second side surface 10d connects first surface 10a and second surface 10b. Second side surface 10d is located opposite to first side surface 10c in the y direction.

As shown in FIG. 1, heater glaze 12 and die bonding glaze 13 are provided on a part of first surface 10a. That is, heater glaze 12 and die bonding glaze 13 are so-called partial glazes.

As shown in FIG. 1, heater glaze 12 is disposed between first side surface 10c and die bonding glaze 13 in the y direction. Die bonding glaze 13 is disposed between second side surface 10d and heater glaze 12 in the y direction.

Heater glaze 12 and die bonding glaze 13 are made of, for example, amorphous glass. Each of heater glaze 12 and die bonding glaze 13 may be lower in thermal conductivity than substrate 10.

In a plan view of first surface 10a, heater glaze 12 extends in the x direction. Heater glaze 12 is disposed below heat-generating resistor 30. Heater glaze 12 suppresses dissipation of heat from heat-generating resistor 30 to substrate 10. Heater glaze 12 is a heat storage layer. Heater glaze 12 protrudes from a portion of first surface 10a. Heater glaze 12 results in an increase in height of heat-generating resistor 30 from first surface 10a. Heat-generating resistor 30 is pressed against a print medium (e.g., heat-sensitive recording paper).

Die bonding glaze 13 is spaced apart from heater glaze 12 in the y direction. In a plan view of first surface 10a, die bonding glaze 13 extends in the x direction. Die bonding glaze 13 supports a part of wiring layer 20 and drive circuit 40.

As shown in FIG. 3, flattened layer 15 is provided on first surface 10a. A material of flattened layer 15 includes glass. The material of flattened layer 15 may include alumina. Specifically, flattened layer 15 is made of, for example, amorphous glass.

Flattened layer 15 includes a first flattened layer 16 and a second flattened layer 17. As shown in FIG. 1, in a plan view of first surface 10a, first flattened layer 16 is disposed between heater glaze 12 and die bonding glaze 13. Second flattened layer 17 is disposed opposite to first flattened layer 16 in the y direction when viewed from heater glaze 12. That is, second flattened layer 17 is disposed between heater glaze 12 and first side surface 10c.

As shown in FIG. 3, flattened layer 15 is contiguous to an end portion SP of heater glaze 12. End portion SP is disposed between heat-generating resistor 30 and first side surface 10c in the y direction. That is, end portion SP is a portion where heater glaze 12 is contiguous to second flattened layer 17.

As shown in FIG. 3, flattened layer 15 is smaller in thickness in the z direction than each of heater glaze 12 and die bonding glaze 13. Flattened layer 15 is smaller in surface roughness than first surface 10a. Therefore, by disposing wiring layer 20 on flattened layer 15, a break in wiring layer 20 caused by the surface roughness of first surface 10a can be suppressed.

Wiring layer 20 is disposed on heater glaze 12, on die bonding glaze 13, and on flattened layer 15. Wiring layer 20 forms a conductive path via which a current flows through heat-generating resistor 30. Wiring layer 20 includes a plurality of individual wiring lines 25 and a common wiring line 21.

Each of the plurality of individual wiring lines 25 partially passes a current through heat-generating resistor 30. The plurality of individual wiring lines 25 are disposed on heater glaze 12, die bonding glaze 13 and first flattened layer 16. As shown in FIG. 1, each of the plurality of individual wiring lines 25 includes a main body portion 25a, a tip portion 25b and an electrode portion 25c. Tip portion 25b is provided at one end of main body portion 25a. Electrode portion 25c is provided at the other end of main body portion 25a.

As shown in FIGS. 1 and 2, tip portion 25b extends along the y direction. Tip portion 25b is disposed on heater glaze 12 to overlap heat-generating resistor 30. Tip portion 25b and a protruding portion 22b are alternately disposed with a spacing therebetween in the x direction.

Electrode portion 25c is disposed on die bonding glaze 13. Electrode portion 25c is electrically connected to a driver IC through conductive wire 41.

The plurality of individual wiring lines 25 are, for example, gold (Au) wiring lines. The plurality of individual wiring lines 25 are made of, for example, a gold particulate sintered material. That is, a material of the plurality of individual wiring lines 25 includes gold.

As shown in FIGS. 1-3, common wiring line 21 is disposed on heater glaze 12, die bonding glaze 13, first flattened layer 16, and second flattened layer 17. Common wiring line 21 is located opposite to the plurality of individual wiring lines 25 in the y direction when viewed from heat-generating resistor 30.

Common wiring line 21 includes coupling portion 22 and an auxiliary electrode portion 23. Coupling portion 22 extends from heat-generating resistor 30 toward second flattened layer 17 of flattened layer 15. Specifically, coupling portion 22 includes a coupling main body portion 22a and a plurality of protruding portions 22b. Each of the plurality of protruding portions 22b is disposed on heater glaze 12 to overlap heat-generating resistor 30. The plurality of protruding portions 22b are disposed at equal intervals in the x direction. The plurality of protruding portions 22b extend from heat-generating resistor 30 toward first side surface 10c in the y direction.

As shown in FIG. 1, the plurality of protruding portions 22b are contiguous to coupling main body portion 22a. Coupling main body portion 22a is disposed on heater glaze 12 and a part of second flattened layer 17. Coupling main body portion 22a is disposed between protruding portions 22b and first side surface 10c in the y direction. Coupling main body portion 22a extends along the x direction.

Coupling portion 22 is, for example, a gold (Au) wiring line. Coupling portion 22 is made of, for example, a gold particulate sintered material. That is, a material of coupling portion 22 includes gold.

Auxiliary electrode portion 23 reduces a resistance value of coupling portion 22. Auxiliary electrode portion 23 is connected to coupling portion 22. Specifically, as shown in FIG. 3, auxiliary electrode portion 23 is disposed on second flattened layer 17 to cover a part of coupling main body portion 22a. Auxiliary electrode portion 23 extends along the x direction. Auxiliary electrode portion 23 is connected to the plurality of protruding portions 22b. The plurality of protruding portions 22b are coupled to each other by coupling main body portion 22a. Auxiliary electrode portion 23 is, for example, a silver (Ag) wiring line. Auxiliary electrode portion 23 is made of, for example, a silver particulate sintered material. That is, a material of auxiliary electrode portion 23 includes silver.

Auxiliary electrode portion 23 includes a bypass portion 23a. Bypass portion 23a extends along the -y direction from both ends of auxiliary electrode portion 23 in the x direction so as to bypass the plurality of individual wiring lines 25. Bypass portion 23a is disposed on second flattened layer 17, heater glaze 12, first flattened layer 16, and die bonding glaze 13.

As shown in FIGS. 1-3, heat-generating resistor 30 is disposed at the top of heater glaze 12. Heat-generating resistor 30 extends in the x direction. In a plan view of first surface 10a, heat-generating resistor 30 may, for example, have a strip shape. Heat-generating resistor 30 protrudes opposite to substrate 10 in the z direction with respect to heater glaze 12.

Heat-generating resistor 30 is connected to wiring layer 20. Specifically, as shown in FIG. 2, heat-generating resistor 30 is connected to the plurality of protruding portions 22b of common wiring line 21 and tip portions 25b of the plurality of individual wiring lines 25. In a plan view of first surface 10a, heat-generating resistor 30 is disposed to intersect the plurality of protruding portions 22b and the plurality of tip portions 25b. Heat-generating resistor 30 is formed to extend over the plurality of protruding portions 22b and tip portions 25b. Heat generation by heat-generating resistor 30 makes it possible to perform printing on a printing medium (e.g., heat-sensitive recording paper).

As shown in FIG. 3, protective layer 33 protects heat-generating resistor 30. Protective layer 33 may protect common wiring line 21 and the plurality of individual wiring lines 25. Specifically, protective layer 33 is formed on heat-generating resistor 30 and wiring layer 20 to cover heat-generating resistor 30 and wiring layer 20. Protective layer 33 is an insulating layer. Protective layer 33 is made of, for example, amorphous glass.

As shown in FIG. 1, drive circuit 40 selectively passes a current through the plurality of individual wiring lines 25. Drive circuit 40 is, for example, a driver IC. Drive circuit 40 is disposed on die bonding glaze 13. Drive circuit 40 may be sealed by a sealing member (not shown). The sealing member has an electrically insulating property. The sealing member is made of, for example, an insulating resin material such as an epoxy resin.

The feature of thermal print head 1 according to the first embodiment is that a part of auxiliary electrode portion 23 covers coupling portion 22 as shown in FIG. 3.

When the whole of auxiliary electrode portion 23 is formed on coupling portion 22, a void is formed in a larger region in auxiliary electrode portion 23. The void is formed due to a residue of an etching mask disposed on coupling portion 22. When there is a void in auxiliary electrode portion 23, a projection is formed on a surface of auxiliary electrode portion 23. The projection may lead to poor printing.

In contrast, in thermal print head 1 according to the first embodiment, a part of auxiliary electrode portion 23 covers coupling portion 22. Therefore, since auxiliary electrode portion 23 partially covers coupling portion 22, a void is formed in a smaller region in auxiliary electrode portion 23 and formation of the void in auxiliary electrode portion 23 is suppressed.

As shown in FIG. 3, coupling portion 22 includes a first end portion E1 farthest from end portion SP in the y direction. First end portion E1 is a portion of coupling portion 22 closest to first side surface 10c.

Auxiliary electrode portion 23 includes a second end portion E2 farthest from end portion SP in the y direction. Second end portion E2 is a portion of auxiliary electrode portion 23 closest to first side surface 10c. Auxiliary electrode portion 23 includes a fourth end portion E4 located opposite to second end portion E2 in the y direction. Fourth end portion E4 is a portion of auxiliary electrode portion 23 closest to heat-generating resistor 30. Fourth end portion E4 is disposed between first end portion E1 and heat-generating resistor 30 in the y direction. In thermal print head 1 according to the first embodiment, the position of fourth end portion E4 in the y direction is the same as the position of end portion SP in the y direction.

Flattened layer 15 includes a third end portion E3 farthest from end portion SP in the y direction. Third end portion E3 is a portion of flattened layer 15 closest to first side surface 10c. That is, in second flattened layer 17, third end portion E3 is located opposite to end portion SP in the y direction.

As shown in FIG. 3, second end portion E2 is disposed between first end portion E1 and third end portion E3 in the y direction. With such a configuration, a part of auxiliary electrode portion 23 covers coupling portion 22. From a different perspective, in a plan view of first surface 10a, coupling portion 22 does not overlap the whole of auxiliary electrode portion 23 but overlaps a part of auxiliary electrode portion 23. As a result, formation of a void in auxiliary electrode portion 23 disposed on coupling portion 22 is suppressed.

A distance from end portion SP to first end portion E1 in the y direction is defined as a first distance L1. A distance from end portion SP to second end portion E2 in the y direction is defined as a second distance L2. First distance L1 may be 1/2 times or less as long as second distance L2, or may be 1/3 times or less as long as second distance L2. A width of a region where auxiliary electrode portion 23 overlaps coupling portion 22 in the y direction (in the first embodiment, a distance from fourth end portion E4 to first end portion E1 in the y direction) may be equal to or less than 300 μm. With such a configuration, a contact area between auxiliary electrode portion 23 and coupling portion 22 is small and formation of a void in auxiliary electrode portion 23 disposed on coupling portion 22 is suppressed.

A distance from end portion SP to third end portion E3 in the y direction is defined as a third distance L3. Second distance L2 is equal to or shorter than third distance L3 and is longer than first distance L1. Therefore, a part of auxiliary electrode portion 23 is in direct contact with second flattened layer 17. From a different perspective, in a plan view of first surface 10a, the whole of auxiliary electrode portion 23 overlaps second flattened layer 17. With such a configuration, auxiliary electrode portion 23 is not in contact with first surface 10a of substrate 10. Second flattened layer 17 is smaller in surface roughness than first surface 10a. Therefore, by disposing auxiliary electrode portion 23 at the position where the whole of auxiliary electrode portion 23 overlaps second flattened layer 17, separation of auxiliary electrode portion 23 caused by the surface roughness of first surface 10a is suppressed.

Second distance L2 may be 900 μm. From a different perspective, a distance from fourth end portion E4 to second end portion E2 may be 900 μm. Third distance L3 may be 1100 μm. A distance from third end portion E3 to first side surface 10c in the y direction may be 300 μm.

The position of fourth end portion E4 in the y direction may not be the same as the position of end portion SP in the y direction. In the y direction, fourth end portion E4 may be disposed between first end portion E1 and end portion SP, or may be disposed between heat-generating resistor 30 and end portion SP.

The void formed in auxiliary electrode portion 23 is evaluated as follows.

In a cross section along the y direction, an occupied area of a void formed on coupling portion 22 is equal to or less than 600 μm². The void formed on coupling portion 22 can be identified by observing a cross section of auxiliary electrode portion 23. Specifically, a cross section of thermal print head 1 is first machined with a cross section polisher (CP). The cross section is observed using a scanning electron microscope (SEM) (model number: JST-IT100) manufactured by Japan Electron Optics Laboratory Co., Ltd., whereby a cross-sectional image of auxiliary electrode portion 23 can be obtained. The occupied area of the void can be determined from the cross-sectional image.

### Method for Manufacturing Thermal Print Head

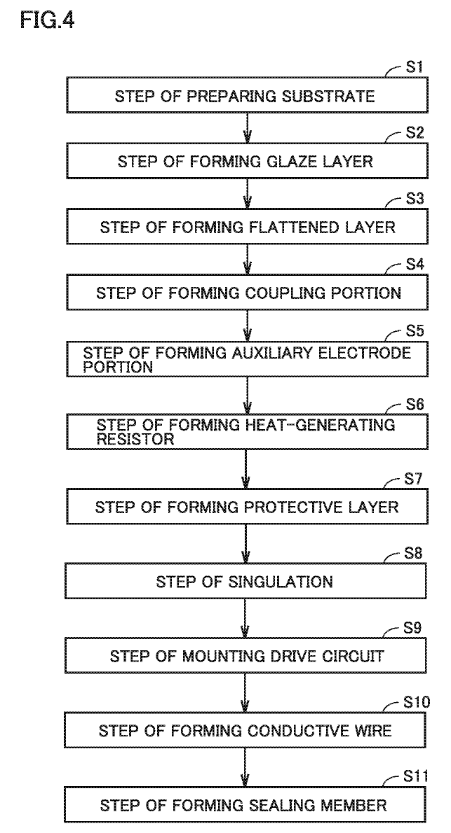

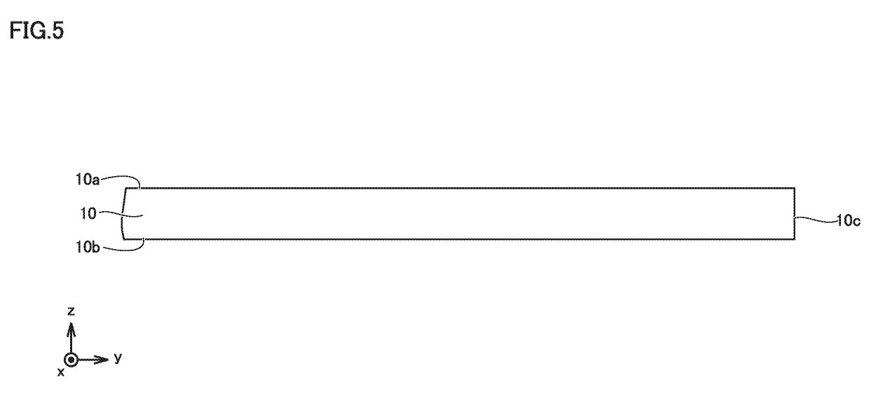

A method for manufacturing thermal print head 1 according to the first embodiment will be described below. FIG. 4 is a flowchart showing the method for manufacturing thermal print head 1 according to the first embodiment. Each of FIGS. 5-8 and FIGS. 10-12 is a partially enlarged schematic cross-sectional view showing one step in the method for manufacturing the thermal print head according to the first embodiment.

First, the step of preparing substrate 10 (S1) is performed. In this step (S1), as shown in FIG. 5, substrate 10 having first surface 10a and second surface 10b is prepared. Substrate 10 is, for example, a ceramic substrate such as an alumina substrate.

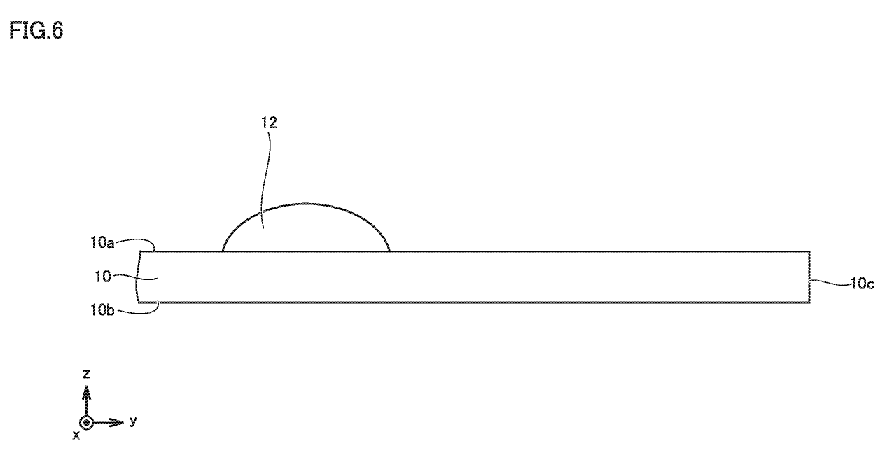

Next, the step of forming a glaze layer (S2) is performed. In this step (S2), as shown in FIG. 6, the glaze layer is formed on first surface 10a of substrate 10. Specifically, a glass paste that will form heater glaze 12 and die bonding glaze 13 is printed on first surface 10a of substrate 10. The glass paste is fired. In this way, heater glaze 12 and die bonding glaze 13 (not shown) are, for example, formed as the glaze layer.

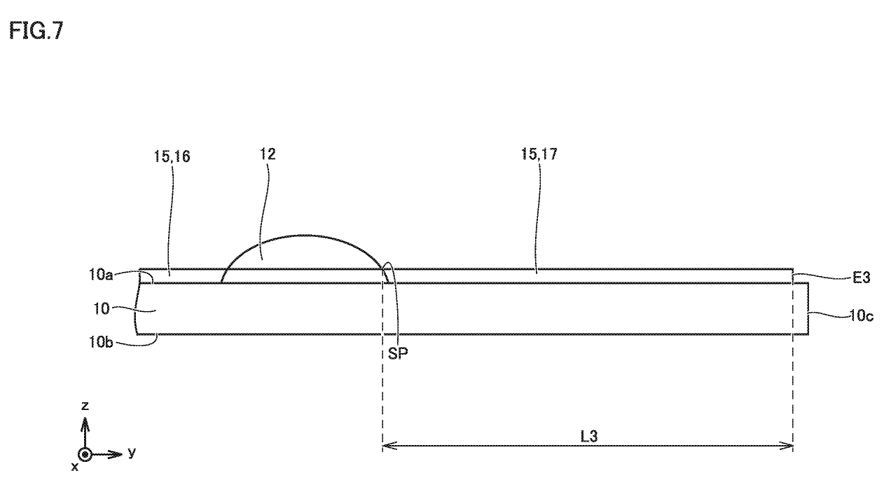

Next, the step of forming flattened layer 15 (S3) is performed. In this step (S3), as shown in FIG. 7, flattened layer 15 is formed on a region of first surface 10a exposed from heater glaze 12 and die bonding glaze 13 as the glaze layer. For example, a glass paste that will form flattened layer 15 is printed on the region of first surface 10a exposed from heater glaze 12 and die bonding glaze 13. The glass paste is fired. In this way, flattened layer 15 is formed. Flattened layer 15 includes, for example, first flattened layer 16 and second flattened layer 17.

Next, the step of forming the coupling portion (S4) is performed. In this step (S4), the plurality of individual wiring lines 25 and coupling portion 22 are formed on heater glaze 12, die bonding glaze 13, and a part of flattened layer 15. First, a paste containing a conductive substance such as a gold (Au) particulate is, for example, printed on heater glaze 12, die bonding glaze 13 and flattened layer 15. At this time, the paste is printed on a part of second flattened layer 17, not on the whole of flattened layer 15. Specifically, the paste is partially printed on second flattened layer 17 such that the paste is not disposed in a region between first end portion E1 and third end portion E3 in the y direction. Next, the partially printed paste is fired, thereby forming a first conductor layer.

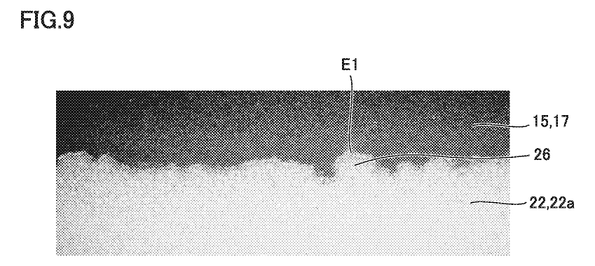

FIG. 9 is a partially enlarged plan view showing the shape of first end portion E1 of coupling portion 22. Coupling portion 22 shown in FIG. 9 corresponds to the first conductor layer formed by firing the paste partially printed on second flattened layer 17. By firing the paste partially printed on second flattened layer 17, first end portion E1 has a wavy shape, not a linear shape. From a different perspective, in a plan view of first surface 10a, first end portion E1 includes a protrusion 26. The waviness in first end portion E1 is equal to or more than 10 μm and equal to or less than 60 μm. By setting the waviness of first end portion E1 to 10 μm or more, the adhesion between coupling portion 22 and auxiliary electrode portion 23 (or flattened layer 15) is improved due to the anchoring effect. On the other hand, by setting the waviness to 60 μm or less, the shape stability of coupling portion 22 is maintained, and the flatness of auxiliary electrode portion 23 formed thereon can be secured (i.e., formation of projections due to voids is suppressed). In a plan view of first surface 10a, the waviness in first end portion E1 is measured using a laser microscope (model number: VK-3050) manufactured by Keyence Corporation.

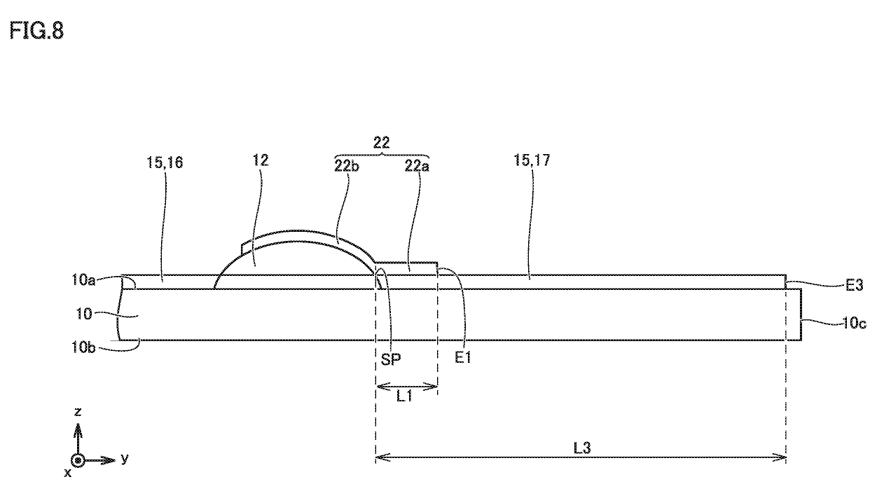

Next, the first conductor layer is patterned through the photolithography step. The photolithography step includes the step of forming an etching mask through the exposure step and the development step, and the step of etching the first conductor layer using the etching mask. In this way, the plurality of individual wiring lines 25 and coupling portion 22 of common wiring line 21 shown in FIG. 8 are formed.

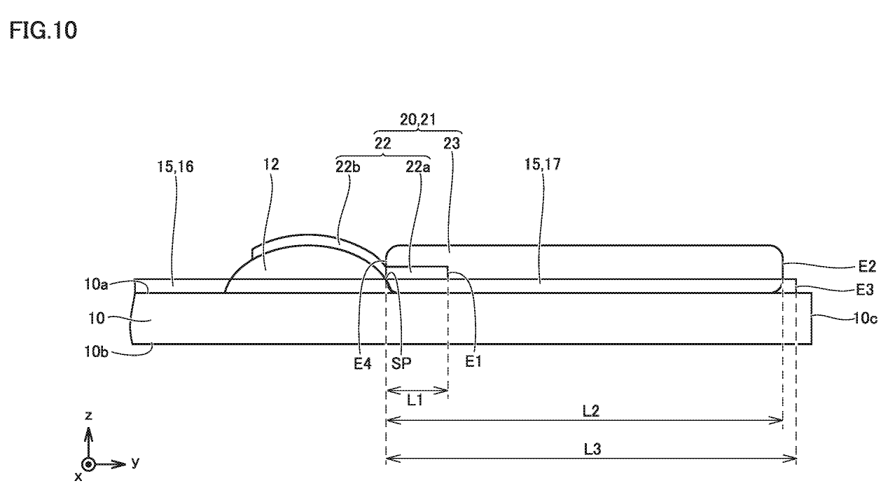

Next, the step of forming auxiliary electrode portion 23 (S5) is performed. In this step (S5), as shown in FIG. 10, a resinate paste containing a conductive substance such as a silver (Ag) particulate is printed on second flattened layer 17 to cover a part of coupling portion 22. A glass paste containing a conductive substance such as a silver (Ag) particulate and a glass frit is printed on a part of the resinate paste. The above-described resinate paste and the above-described glass paste are fired, thereby forming a second conductor layer. The second conductor layer is patterned through the photolithography step. The photolithography step includes the step of forming an etching mask through the exposure step and the development step, and the step of etching the second conductor layer using the etching mask. In this way, common wiring line 21 including auxiliary electrode portion 23 is formed.

In the step of forming the coupling portion (S4), the paste containing a conductive substance such as a gold (Au) particulate is partially printed on second flattened layer 17. Therefore, the whole of the second conductor layer is not formed on the first conductor layer where there is a residue, and a part of the second conductor layer is formed on the first conductor layer. That is, a contact area between auxiliary electrode portion 23 and coupling portion 22 is small and formation of a void in auxiliary electrode portion 23 disposed on coupling portion 22 is suppressed.

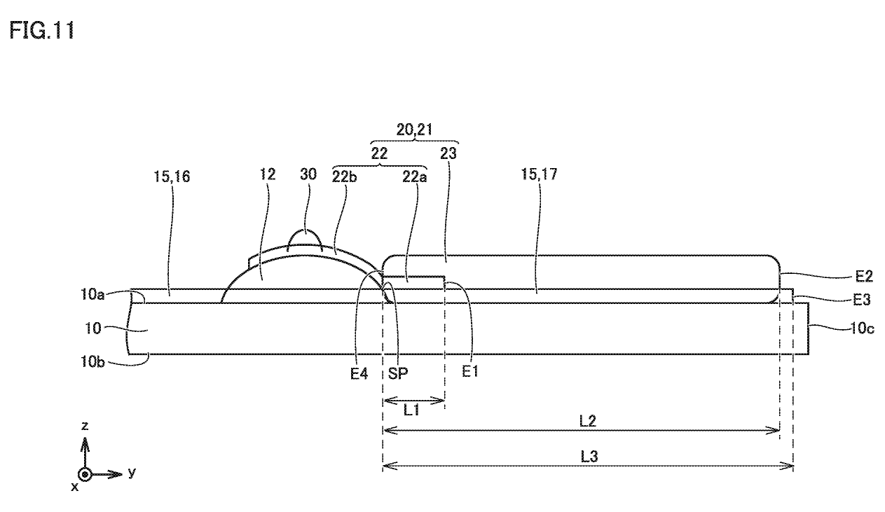

Next, the step of forming heat-generating resistor 30 (S6) is performed. In this step (S6), as shown in FIG. 11, heat-generating resistor 30 is, for example, formed on heater glaze 12, the plurality of protruding portions 22b, and the plurality of tip portions 25b. First, a resistor paste is applied onto heater glaze 12, the plurality of protruding portions 22b, and the plurality of tip portions 25b. The resistor paste contains, for example, a conductive material such as ruthenium oxide, tantalum nitride, tantalum, or silver vanadium, and glass. Then, the resistor paste is fired. In this way, heat-generating resistor 30 is formed.

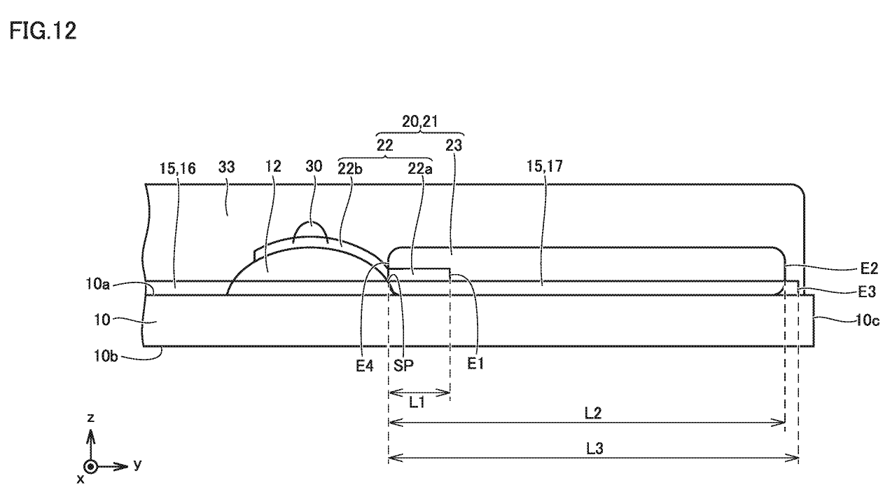

Next, the step of forming protective layer 33 (S7) is performed. In this step (S7), as shown in FIG. 12, protective layer 33 is formed on heater glaze 12, flattened layer 15, wiring layer 20, and heat-generating resistor 30. Specifically, a glass paste is printed on heater glaze 12, flattened layer 15, wiring layer 20, and heat-generating resistor 30. Next, the glass paste is fired. As a result, protective layer 33 is formed.

Next, the step of singulation (S8) is performed. In this step (S8), a stacked structure including substrate 10, heater glaze 12, flattened layer 15, wiring layer 20, heat-generating resistor 30, and protective layer 33 is divided. For example, a groove is formed in substrate 10 by a laser scribe method. The stacked structure is cut along the groove. In this way, the above-described stacked structure is singulated.

Next, the step of mounting drive circuit 40 (S9) is performed. In this step (S9), drive circuit 40 is mounted on die bonding glaze 13 (see FIG. 1). For example, drive circuit 40 is fixed to die bonding glaze 13 by using a joining member (not shown) such as a resin adhesive or solder.

Next, the step of forming conductive wire 41 (S10) is performed. In this step (S10), conductive wire 41 is bonded. Conductive wire 41 is bonded to drive circuit 40 and electrode portions 25c of the plurality of individual wiring lines 25 (see FIG. 1).

Next, the step of forming the sealing member (S11) is performed. In this step (S11), drive circuit 40 is sealed by the sealing member. For example, potting of a sealing resin material is performed on drive circuit 40. The sealing resin material is hardened. In this way, the sealing member is formed. Thermal print head 1 according to the first embodiment as shown in FIGS. 1-3 is thus manufactured.

### Functions and Effects

Thermal print head 1 according to the present disclosure includes: substrate 10; heater glaze 12; flattened layer 15; wiring layer 20; and heat-generating resistor 30. Substrate 10 has first surface 10a. Heater glaze 12 is provided on first surface 10a. Flattened layer 15 is provided on first surface 10a. Flattened layer 15 is contiguous to end portion SP of heater glaze 12. Wiring layer 20 is disposed on heater glaze 12 and a part of flattened layer 15. Heat-generating resistor 30 is disposed on heater glaze 12. Wiring layer 20 includes a plurality of individual wiring lines 25, and common wiring line 21. Common wiring line 21 is located opposite to the plurality of individual wiring lines 25 when viewed from heat-generating resistor 30. Common wiring line 21 includes coupling portion 22 and auxiliary electrode portion 23. Coupling portion 22 extends from heat-generating resistor 30 toward flattened layer 15. Auxiliary electrode portion 23 is connected to coupling portion 22. A direction in which coupling portion 22 extends is defined as a y direction. Coupling portion 22 includes first end portion E1 farthest from end portion SP in the y direction. Auxiliary electrode portion 23 includes second end portion E2 farthest from end portion SP in the y direction. Flattened layer 15 includes third end portion E3 farthest from end portion SP in the y direction. Second end portion E2 is disposed between first end portion E1 and third end portion E3 in the y direction.

With such a configuration, the whole of auxiliary electrode portion 23 does not cover coupling portion 22. That is, since auxiliary electrode portion 23 partially covers coupling portion 22, formation of a void in auxiliary electrode portion 23 is suppressed.

In thermal print head 1 described above, first distance L1 from end portion SP to first end portion E1 in the y direction is 1/2 times or less as long as second distance L2 from end portion SP to second end portion E2 in the y direction.

With such a configuration, auxiliary electrode portion 23 partially covers coupling portion 22. Therefore, formation of a void in auxiliary electrode portion 23 is suppressed.

In thermal print head 1 described above, first distance L1 is 1/3 times or less as long as second distance L2.

With such a configuration, auxiliary electrode portion 23 partially covers coupling portion 22. Therefore, formation of a void in auxiliary electrode portion 23 is suppressed.

In thermal print head 1 described above, a width of a region where auxiliary electrode portion 23 overlaps coupling portion 22 in the y direction is equal to or less than 300 μm.

With such a configuration, auxiliary electrode portion 23 partially covers coupling portion 22. Therefore, formation of a void in auxiliary electrode portion 23 is suppressed.

In thermal print head 1 described above, a material of coupling portion 22 includes gold.

The paste containing a conductive substance such as a silver (Ag) particulate is partially printed on second flattened layer 17, whereby auxiliary electrode portion 23 partially covers coupling portion 22. Therefore, formation of a void in auxiliary electrode portion 23 is suppressed.

In thermal print head 1 described above, a material of auxiliary electrode portion 23 includes silver.

The paste containing a conductive substance such as a silver (Ag) particulate is printed on second flattened layer 17, whereby auxiliary electrode portion 23 partially covers coupling portion 22. Therefore, formation of a void in auxiliary electrode portion 23 is suppressed.

In thermal print head 1 described above, in a plan view of first surface 10a, first end portion E1 includes protrusion 26.

With such a configuration, by firing the paste partially printed on second flattened layer 17 to form coupling portion 22, first end portion E1 has a wavy shape, not a linear shape.

In thermal print head 1 described above, in a cross section along the y direction, an occupied area of a void formed on coupling portion 22 is equal to or less than 600 μm².

With such a configuration, formation of a projection on the surface of auxiliary electrode portion 23 is suppressed.

### Second Embodiment

### Configuration of Thermal Print Head

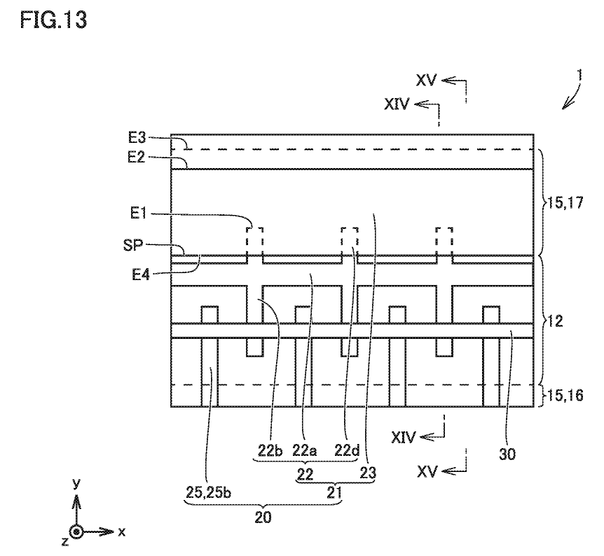

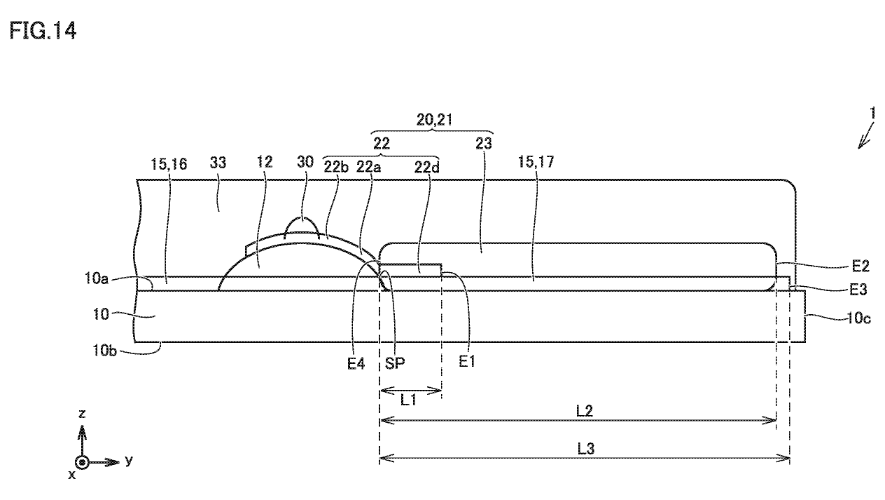

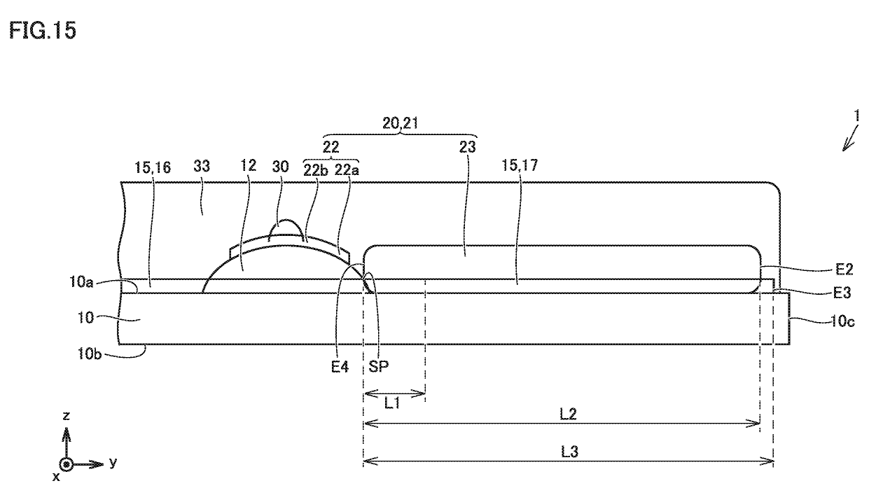

FIG. 13 is a partially enlarged schematic plan view of thermal print head 1 according to a second embodiment. FIG. 13 corresponds to FIG. 2. FIG. 14 is a partially enlarged schematic cross-sectional view taken along line XIV-XIV in FIG. 13. FIG. 15 is a partially enlarged schematic cross-sectional view taken along line XV-XV in FIG. 13. FIGS. 14 and 15 correspond to FIG. 3. Thermal print head 1 shown in FIGS. 13-15 basically has the same configuration and the same effects as those of thermal print head 1 shown in FIGS. 1-3. However, thermal print head 1 shown in FIGS. 13-15 is different from thermal print head 1 shown in FIGS. 1-3 in that coupling portion 22 includes a plurality of extending portions 22d extending in the y direction.

As shown in FIG. 13, the plurality of extending portions 22d are contiguous to coupling main body portion 22a. Coupling main body portion 22a is disposed on heater glaze 12. Each of the plurality of extending portions 22d is disposed on heater glaze 12 and a part of second flattened layer 17. The plurality of extending portions 22d extend from coupling main body portion 22a toward first side surface 10c in the y direction. The plurality of extending portions 22d are disposed at equal intervals in the x direction. That is, between the plurality of extending portions 22d in the x direction, a part of second flattened layer 17 is exposed from coupling portion 22.

As shown in FIGS. 13 and 14, auxiliary electrode portion 23 is disposed on second flattened layer 17 to cover a part of each of the plurality of extending portions 22d of coupling portion 22. From a different perspective, as shown in FIG. 15, auxiliary electrode portion 23 is in contact with second flattened layer 17 exposed from coupling portion 22 (a void formed between the plurality of extending portions 22d in the x direction).

With such a configuration, a contact area between auxiliary electrode portion 23 and coupling portion 22 is smaller. As a result, formation of a void in auxiliary electrode portion 23 disposed on coupling portion 22 is suppressed.

Further, in thermal print head 1 according to the second embodiment, auxiliary electrode portion 23 is disposed in gaps between the plurality of extending portions 22d spaced apart in the x direction. Consequently, auxiliary electrode portion 23 comes into direct contact with second flattened layer 17 exposed from coupling portion 22. This structure produces an anchoring effect, thereby improving the adhesion strength of auxiliary electrode portion 23 to the substrate side. As a result, peeling of auxiliary electrode portion 23 is suppressed.

### Functions and Effects

In thermal print head 1 described above, in a plan view of first surface 10a, a direction perpendicular to the y direction is defined as an x direction. Coupling portion 22 includes coupling main body portion 22a and a plurality of extending portions 22d. Coupling main body portion 22a extends in the x direction. The plurality of extending portions 22d are contiguous to coupling main body portion 22a and extend in the y direction. The plurality of extending portions 22d are spaced apart from each other in the x direction.

With such a configuration, a contact area between auxiliary electrode portion 23 and coupling portion 22 is smaller. As a result, formation of a void in auxiliary electrode portion 23 disposed on coupling portion 22 is suppressed.

Hereinafter, various configurations of the present disclosure will be summarized as additional aspects.

### Additional Aspect 1

A thermal print head comprising:

a substrate having a first surface;

a heater glaze provided on the first surface;

a flattened layer provided on the first surface, the flattened layer being contiguous to an end portion of the heater glaze;

a wiring layer disposed on the heater glaze and a part of the flattened layer; and

a heat-generating resistor disposed on the heater glaze, wherein

the wiring layer includes a plurality of individual wiring lines, and a common wiring line located opposite to the plurality of individual wiring lines when viewed from the heat-generating resistor,

the common wiring line includes a coupling portion extending from the heat-generating resistor toward the flattened layer, and an auxiliary electrode portion connected to the coupling portion,

a direction in which the coupling portion extends is defined as a y direction,

the coupling portion includes a first end portion farthest from the end portion in the y direction,

the auxiliary electrode portion includes a second end portion farthest from the end portion in the y direction,

the flattened layer includes a third end portion farthest from the end portion in the y direction, and

the second end portion is disposed between the first end portion and the third end portion in the y direction.

### Additional Aspect 2

The thermal print head according to Additional Aspect 1, wherein

a first distance from the end portion to the first end portion in the y direction is 1/2 times or less as long as a second distance from the end portion to the second end portion in the y direction.

### Additional Aspect 3

The thermal print head according to Additional Aspect 2, wherein

the first distance is 1/3 times or less as long as the second distance.

### Additional Aspect 4

The thermal print head according to any one of Additional Aspects 1 to 3, wherein

a width of a region where the auxiliary electrode portion overlaps the coupling portion in the y direction is equal to or less than 300 μm.

### Additional Aspect 5

The thermal print head according to any one of Additional Aspects 1 to 4, wherein

a material of the coupling portion includes gold.

### Additional Aspect 6

The thermal print head according to any one of Additional Aspects 1 to 5, wherein

a material of the auxiliary electrode portion includes silver.

### Additional Aspect 7

The thermal print head according to any one of Additional Aspects 1 to 6, wherein

in a plan view of the first surface, the first end portion includes a protrusion.

### Additional Aspect 8

The thermal print head according to any one of Additional Aspects 1 to 7, wherein

in a plan view of the first surface, a direction perpendicular to the y direction is defined as an x direction,

the coupling portion includes a coupling main body portion extending in the x direction, and a plurality of extending portions being contiguous to the coupling main body portion and extending in the y direction, and

the plurality of extending portions are spaced apart from each other in the x direction.

### Additional Aspect 9

The thermal print head according to any one of Additional Aspects 1 to 8, wherein

in a cross section along the y direction, an occupied area of a void formed on the coupling portion is equal to or less than 600 μm².

Although the embodiments of the present disclosure have been described, it should be understood that the embodiments disclosed herein are illustrative and non-restrictive in every respect. The scope of the present disclosure is defined by the terms of the claims, and is intended to include any modifications within the scope and meaning equivalent to the terms of the claims.

What is claimed is:

1. A thermal print head comprising:
a substrate having a first surface;
a heater glaze provided on the first surface;
a flattened layer provided on the first surface, the flattened layer being contiguous to an end portion of the heater glaze;
a wiring layer disposed on the heater glaze and a part of the flattened layer; and
a heat-generating resistor disposed on the heater glaze, wherein
the wiring layer includes a plurality of individual wiring lines, and a common wiring line located opposite to the plurality of individual wiring lines when viewed from the heat-generating resistor,
the common wiring line includes a coupling portion extending from the heat-generating resistor toward the flattened layer, and an auxiliary electrode portion connected to the coupling portion,
a direction in which the coupling portion extends is defined as a y direction,
the coupling portion includes a first end portion farthest from the end portion in the y direction,
the auxiliary electrode portion includes a second end portion farthest from the end portion in the y direction,
the flattened layer includes a third end portion farthest from the end portion in the y direction, and
the second end portion is disposed between the first end portion and the third end portion in the y direction.

2. The thermal print head according to claim 1, wherein
a first distance from the end portion to the first end portion in the y direction is 1/2 times or less as long as a second distance from the end portion to the second end portion in the y direction.

3. The thermal print head according to claim 2, wherein
the first distance is 1/3 times or less as long as the second distance.

4. The thermal print head according to claim 1, wherein
a width of a region where the auxiliary electrode portion overlaps the coupling portion in the y direction is equal to or less than 300 μm.

5. The thermal print head according to claim 1, wherein
a material of the coupling portion includes gold.

6. The thermal print head according to claim 1, wherein
a material of the auxiliary electrode portion includes silver.

7. The thermal print head according to claim 1, wherein
in a plan view of the first surface, the first end portion includes a protrusion.

8. The thermal print head according to claim 1, wherein
in a plan view of the first surface, a direction perpendicular to the y direction is defined as an x direction,
the coupling portion includes a coupling main body portion extending in the x direction, and a plurality of extending portions being contiguous to the coupling main body portion and extending in the y direction, and
the plurality of extending portions are spaced apart from each other in the x direction.

9. The thermal print head according to claim 1, wherein
in a cross section along the y direction, an occupied area of a void formed on the coupling portion is equal to or less than 600 μm².
